(19) United States
(12) Patent Application Publication
(10) Pub. No.: US 2025/0244601 A1
(43) Pub. Date: Jul. 31, 2025

(54) SPECKLE-ELIMINATING LIGHT PATH STRUCTURE AND LASER PROJECTION APPARATUS

(71) Applicant: Shenzhen Oceanwing Smart Innovations Technology Co., Ltd., Shenzhen (CN)

(72) Inventor: Xiaofeng Tang, Shenzhen (CN)

(21) Appl. No.: 19/039,409

(22) Filed: Jan. 28, 2025

(30) Foreign Application Priority Data
Jan. 29, 2024 (CN) 202410123101.1
Jan. 29, 2024 (CN) 202420224948.4

(51) Int. Cl. G02B 27/48; G02B 26/02

(52) U.S. Cl. CPC G02B 27/48; G02B 26/023

(57) ABSTRACT

A speckle-eliminating light path structure and a laser projection apparatus are provided. The speckle-eliminating light path structure includes a laser light source, a speckle-eliminating element, and a reflective light path assembly. A laser beam emitted by the laser light source enters the speckle-eliminating element, reaches a reflective surface of the reflective light path assembly, is reflected by the reflective surface, and enters the speckle-eliminating element. The laser beam emitted by the laser light source passes through the speckle-eliminating element at least twice in a process of changing a direction through the reflective surface of the reflective light path assembly so as to suppress speckles of the laser beam at least twice, and emits from the speckle-eliminating element. The laser beam transmitted from the speckle-eliminating element emits at an angle of 60° to 90° relative to a surface of the speckle-eliminating element and then enters a post-stage light path.

### CROSS-REFERENCE TO RELATED APPLICATIONS

This application claims priority to Chinese Patent Application No. 202410123101.1, filed on Jan. 29, 2024. This application also claims priority to Chinese Utility Model application Ser. No. 20/242,0224948.4, filed on Jan. 29, 2024. The foregoing applications are incorporated herein by reference in their entirety.

### FIELD

The present disclosure relates to the field of projection display, in particular, to a speckle-eliminating light path structure and a laser projection apparatus.

### BACKGROUND

As a new generation of projection light source, laser has characteristics of high brightness, good monochromaticity and a small light-emitting angle. However, due to high coherence of laser, projection products using laser are usually accompanied by a phenomenon of speckles, which affects consumer experience. Various measures have been taken to reduce the coherence of laser, but an effect of reducing speckles is limited.

### SUMMARY

The present disclosure provides a speckle-eliminating light path structure and a laser projection apparatus, which can effectively improve a speckle-eliminating effect on a laser beam, improve luminous efficacy, and shorten an overall length of the projection light path, and have a compact structure and low cost.

In a first aspect, an example of the present disclosure provides a speckle-eliminating light path structure, including: a laser light source configured to emit a laser beam; a speckle-eliminating element configured to transmit the laser beam emitted by the laser light source; and a reflective light path assembly including a reflective surface, in which the laser beam emitted by the laser light source enters the speckle-eliminating element, then reaches the reflective surface, is reflected by the reflective surface, and enters the speckle-eliminating element; the laser beam emitted by the laser light source passes through the speckle-eliminating element at least twice in a process of changing direction through the reflective surface of the reflective light path assembly so as to suppress speckles of the laser beam at least twice, and emits from the speckle-eliminating element; and the laser beam emitting from the speckle-eliminating element emits at an angle of 60° to 90° with a surface of the speckle-eliminating element and then enters a post-stage light path.

In an example, the reflective light path assembly is provided on a side of the speckle-eliminating element away from the laser light source and includes a first reflective surface and a second reflective surface provided at preset angles; and the laser beam emitted by the laser light source passes through the speckle-eliminating element for the first time and is incident on the first reflective surface, is reflected by the first reflective surface to the second reflective surface, and is reflected by the second reflective surface and then passes through the speckle-eliminating element for the second time and emits.

In an example, an included angle between an optical axis of the laser beam passing through the speckle-eliminating element for the first time and the surface of the speckle-eliminating element is in a range of 60° to 90°.

In an example, an included angle formed between a normal of the first reflective surface and the surface of the speckle-eliminating element is in a range of 45°±15°; and an included angle formed between a normal of the second reflective surface and the surface of the speckle-eliminating element is in a range of 45°±15°.

In an example, at least one of the first reflective surface and the second reflective surface is plane or a curved surface, and the curved surface is a concave surface.

In examples, the concave surface is any one of a spherical surface, an even aspherical surface or a free curved surface.

In an example, the first reflective surface and the second reflective surface are separately provided with a reflective film.

In an example, the reflective light path assembly includes a first reflective mirror and a second reflective mirror provided at preset angles, the first reflective mirror is provided with the first reflective surface, and the second reflective mirror is provided with the second reflective surface.

In an example, the reflective light path assembly includes a triangular prism including the first reflective surface and the second reflective surface provided at preset angles and a transmissive surface connecting the first reflective surface and the second reflective surface, the transmissive surface being provided toward the speckle-eliminating element.

In an example, the speckle-eliminating light path structure further includes a driving mechanism, the speckle-eliminating element is a diffusion wheel with a diameter d, and a power output end of the driving mechanism is provided coaxially with the diffusion wheel to drive the diffusion wheel to rotate.

In an example, the diffusion wheel has a disc structure, and the diameter d thereof ranges from 20 mm to 60 mm.

In an example, a minimum distance between the diffusion wheel and the reflective light path assembly is 0.1 d to 2 d.

In an example, a side of the speckle-eliminating element toward the laser light source is further provided with a half-wave plate which is provided coaxially with and connected with the speckle-eliminating element as a whole.

In an example, the speckle-eliminating light path structure further includes a driving mechanism, the speckle-eliminating element is a vibration diffuser, and the driving mechanism drives the vibration diffuser to vibrate in any one of XY plane, YZ plane and XZ plane.

In an example, a shape of the vibration diffuser is rectangular, and a diagonal thereof has a dimension L ranging from 20 mm to 60 mm.

In an example, a minimum distance between the vibration diffuser and the reflective light path assembly is 0.1 L to 2 L.

In a second aspect, an example of the present disclosure provides a laser projection apparatus, including: the speckle-eliminating light path structure as described above; a first lens assembly and an image display device, in which the first lens assembly is provided between the speckle-eliminating light path structure and the image display device and is configured to gather the laser beam from the speckle-eliminating light path structure to the image display device to form an illumination light spot; and a lens configured to project image information from the image display device onto a screen.

In an example, the reflective light path assembly is provided on a side of the speckle-eliminating element away from the laser light source and includes a first reflective surface and a second reflective surface provided at preset angles; and the laser projection apparatus further includes: a second lens assembly provided between the laser light source and the speckle-eliminating element in the speckle-eliminating light path structure and configured to focus the laser beam on the speckle-eliminating element; a third lens assembly provided between the speckle-eliminating element and the reflective light path assembly and configured to cause the laser beam focused on the speckle-eliminating element to diverge and be incident on the first reflective surface of the reflective light path assembly, in which the laser beam from the first reflective surface emits via the second reflective surface and enters the third lens assembly again, is gathered and then enters the speckle-eliminating element again; and a light uniformizing assembly provided between the reflective light path assembly and the first lens assembly and configured to uniformize and shape the laser beam emitting from the speckle-eliminating element.

In an example, the light uniformizing assembly includes a fly-eye lens and a fourth lens assembly, and the fourth lens assembly is provided between the speckle-eliminating element and the fly-eye lens to collimate the laser beam emitting from the speckle-eliminating element.

In an example, the light uniformizing assembly is a quadrangular cylinder with a rectangular or trapezoidal cross section.

In the speckle-eliminating light path structure and the laser projection apparatus provided in examples of the present disclosure, the speckle-eliminating light path structure includes: a laser light source, a speckle-eliminating element and a reflective light path assembly, in which the laser beam emitted by the laser light source enters the speckle-eliminating element, then reaches the reflective surface, is reflected by the reflective surface, and enters the speckle-eliminating element; the laser beam emitted by the laser light source passes through the speckle-eliminating element at least twice in a process of changing direction through the reflective surface of the reflective light path assembly so as to suppress speckles of the laser beam at least twice, and emits from the speckle-eliminating element. Therefore, the direction of the laser beam can be changed by the reflective surface of the reflective light path assembly, so that the laser beam passes through the speckle-eliminating element at least twice, thereby suppressing light spots of the laser beam at least twice and effectively improving the speckle-eliminating effect on the laser beam; at the same time, the laser beam emitting from the speckle-eliminating element emits at an included angle of 60° to 90° with the surface of the speckle-eliminating element, and then enters the post-stage light path, which can improve the luminous efficacy and shorten the overall length of the projection light path. The speckle-eliminating light path structure is applied to the laser projection apparatus, which has compact structure, light weight, strong removability and portability, and is widely used in travel and business.

### BRIEF DESCRIPTION OF THE DRAWINGS

In order to more illustrate examples of the present disclosure or solutions, drawings that need to be used in description of the examples are briefly introduced below. A person of ordinary skill in the art may understand that the drawings in the following description show some examples of the present disclosure, and other drawings can be obtained in accordance with these drawings without inventive work. In the drawings, the same components bear the same reference numerals, and the drawings are not drawn to actual scale.

FIG. 1 is a structure diagram of a speckle-eliminating light path structure according to an example of the present disclosure;

FIG. 2 is a structure diagram of a speckle-eliminating light path structure according to another example of the present disclosure;

FIG. 3 is a structure diagram of a speckle-eliminating light path structure according to another example of the present disclosure;

FIG. 4 is a structure diagram of a speckle-eliminating light path structure according to another example of the present disclosure;

FIG. 5 is a structure diagram of a speckle-eliminating light path structure according to another example of the present disclosure;

FIG. 6 is a structure diagram of a speckle-eliminating light path structure according to another example of the present disclosure;

FIG. 7 is a structure diagram of a speckle-eliminating light path structure according to another example of the present disclosure;

FIG. 8 is a structure diagram of a speckle-eliminating light path structure according to another example of the present disclosure;

FIG. 9 is a structure diagram of a laser projection apparatus according to an example of the present disclosure;

FIG. 10 is a structure diagram of a light uniformizing assembly of the laser projection apparatus shown in FIG. 9; and

FIG. 11 is a structure diagram of another light uniformizing assembly of the laser projection apparatus shown in FIG. 9.

### DESCRIPTION OF REFERENCE NUMERALS

1. Laser light source; R. Red laser; G. Green laser; B. Blue laser;
2. Speckle-eliminating element; 22. Driving mechanism; 23. Half-wave plate;
3. Reflective light path assembly; 30. Reflective surface; 31. First reflective surface; 32. Second reflective surface; 33. Reflective film; 3a. First reflective mirror; 3b. Second reflective mirror; 34. Transmissive surface;
4. Light combining assembly; 5. Second lens assembly; 6. Third lens assembly; 7. Light uniformizing assembly; 71. Fly-eye lens; 72. Fourth lens assembly; 73. Square bar;
8. First lens assembly; 9. Image display device; 10. Lens.

### DETAILED DESCRIPTION

In order to introduce solutions and advantages of examples of the present disclosure, the examples of the present disclosure will be described in combination with the accompanying drawings. The examples to be described are part of examples but not all examples of the present disclosure. Based on the examples of the present disclosure, all other examples obtained by those of ordinary skill in the art without inventive work shall fall within the scope of the present disclosure.

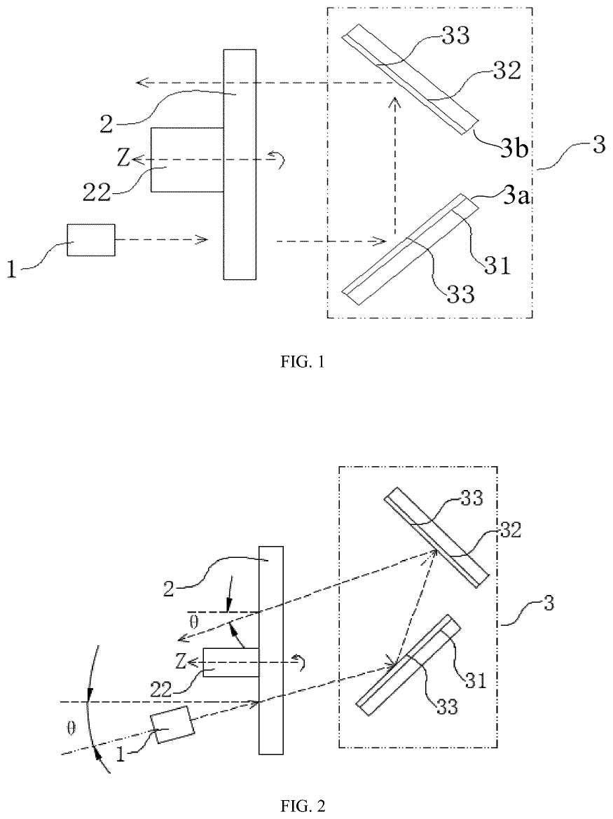

As shown in FIG. 1, an example of the present disclosure provides a speckle-eliminating light path structure, including: a laser light source 1, a speckle-eliminating element 2 (e.g., a speckle-eliminating device) and a reflective light path assembly 3.

The laser light source 1 includes at least one of a red laser R, a green laser G, and a blue laser B. The laser light source 1 is configured to emit a laser beam which has characteristics of high brightness, good monochromaticity and a small light-emitting angle, as well as high coherence. The high coherence of laser may cause speckle effect in laser projection display. Speckle effect refers to that when a coherent light source illuminates optical rough surfaces of which an average fluctuation is of an order of magnitude greater than that of a laser wavelength, such as walls, paper, and frosted glass, scattered light may interfere in space due to a constant phase difference, the same light wave frequency and a consistent vibration direction. Some of the interference is constructive, while others are destructive, with random spatial light intensity distribution and a granular structure. The final result is that light and dark spots, namely speckles, appear on the screen. These unfocused spots are flickering to human eyes, which may easily cause discomfort when viewed for a long time, greatly affect quality of a projection picture, and reduce viewing experience of a user.

The speckle-eliminating element 2 is configured to transmit the laser beam emitted by the laser light source 1 to suppress speckles of the laser. The speckle-eliminating element 2 includes, but is not limited to, a vibration diffuser, a rotary diffusion wheel, a diffractive optical device and/or other elements that can diffuse a light beam or change an angle thereof. The speckle-eliminating element 2 may be a static element or a dynamic element.

The reflective light path assembly 3 includes a reflective surface. The laser beam emitted by the laser light source 1 enters the speckle-eliminating element 2 and reaches the reflective surface, and then is reflected by the reflective surface and enters the speckle-eliminating element 2. The laser beam emitted by the laser light source 1 passes through the speckle-eliminating element 2 at least twice in the process of changing direction through the reflective surfaces of the reflective light path assembly 3, so as to suppress the speckles of the laser beam at least twice and emit from the speckle-eliminating element 2. The laser beam emitting from the speckle-eliminating element 2 emits at an included angle of 60° to 90° with the surface of the speckle-eliminating element 2 and then enters a post-stage light path. That is, an included angle between an optical axis of the laser beam emitting from the speckle-eliminating element 2 and a normal of the speckle-eliminating element 2 ranges from 0° to 30°. The post-stage light path is a light path which the laser emitting from the speckle-eliminating light path structure subsequently enters, and may include optical elements such as a condensing lens, a light uniformizing assembly, an image display device and a lens.

In an example of the present disclosure, the reflective surface of the reflective light path assembly 3 is configured to change the direction of the laser beam, so that the laser beam reflected by the reflective surface can pass through the speckle-eliminating element 2 for multiple times. The speckles of the laser beam can be suppressed once every time the laser beam passes through the speckle-eliminating element 2. The speckles of the laser beam that pass through the speckle-eliminating element 2 for multiple times can be suppressed for multiple times, so that when the laser beam emitting from the speckle-eliminating element 2 is projected onto a screen through the post-stage light path, contrast of the laser speckles can meet use requirements of a product and achieve a good speckle-eliminating effect. At the same time, the laser beam passes through the same speckle-eliminating element 2 for multiple times to suppress the speckles of the laser beam for multiple times, which can shorten the overall length of the projection light path, reduce the number of the speckle-eliminating elements 2, and greatly reduce the fabricating cost.

In addition, the speckle-eliminating element 2 may be a rectangular block with equal thickness or a wedge block with unequal thickness, and the laser beam is incident or emergent along the thickness direction of the speckle-eliminating element 2. The included angle between the optical axis of the laser beam emitting from the speckle-eliminating element 2 and the surface of the speckle-eliminating element 2 ranges from 60° to 90°. On the premise of minimizing the overall volume of the speckle-eliminating light path structure, the emitting laser beams can be incident on other optical elements in the post-stage light path substantially symmetrically with respect to the optical axis without affecting collection efficiency of the laser beams. For example, a light convergence effect of the lens assembly for collecting light can be improved, and for example, when light passes through the light uniformizing device, the uniformity of the display picture can be improved, and the luminous efficacy of the speckle-eliminating light path structure can be improved.

In an example of the present disclosure, the speckle-eliminating light path structure includes the laser light source 1, the speckle-eliminating element 2 and the reflective light path assembly 3. The laser beam emitted by the laser light source 1 enters the speckle-eliminating element 2 and reaches the reflective surface, and then is reflected by the reflective surface and enters the speckle-eliminating element 2. The laser beam emitted by the laser light source 1 passes through the speckle-eliminating element 2 at least twice in the process of changing direction through the reflective surfaces of the reflective light path assembly 3, so as to suppress the speckles of the laser beam at least twice and emit from the speckle-eliminating element 2. Therefore, the direction of the laser beam can be changed by the reflective surface of the reflective light path assembly 3, so that the laser passes through the speckle-eliminating element 2 at least twice, thereby suppressing light spots of the laser beam at least twice, effectively improving the speckle-eliminating effect on the laser beam, and shortening the overall length of the projection light path; at the same time, the laser beam emitting from the speckle-eliminating element 2 emits at an included angle of 60° to 90° with the surface of the speckle-eliminating element 2, and then enters the post-stage light path, which can improve the luminous efficacy of the speckle-eliminating light path structure, and further improve uniformity of picture display.

Details of the speckle-eliminating light path structure according to examples of the present disclosure are described below with reference to the accompanying drawings.

In some examples, the reflective light path assembly 3 is provided on a side of the speckle-eliminating element 2 away from the laser light source 1, and includes a first reflective surface 31 and a second reflective surface 32 provided at preset angles; the laser beam emitted by the laser light source 1 passes through the speckle-eliminating element 2 for the first time and is incident on the first reflective surface 31, is reflected by the first reflective surface 31 to the second reflective surface 32, is reflected by the second reflective surface 32, and then passes through the speckle-eliminating element 2 for the second time and emits.

As shown in FIG. 1, the first reflective surface 31 is located on the optical axis of the laser beam emitting from the speckle-eliminating element 2 at the first time, and the second reflective surface 31 is located on the optical axis of the laser beam incident on the speckle-eliminating element 2 again. The first reflective surface 31 and the second reflective surface 32 are provided at preset angles. The laser beam passing through the speckle-eliminating element 2 at the first time returns to the speckle-eliminating element 2 after being redirected by the first reflective surface 31 and the second reflective surface 32. In this way, the laser beam emitted by the laser light source 1 passes through the same speckle-eliminating element 2 twice, and the speckles of the laser beam are suppressed twice, thus improving the speckle-eliminating effect on the laser.

In addition, reflecting the laser beam twice by providing the first reflective surface 31 and the second reflective surface 32 on the side of the speckle-eliminating element 2 away from the laser light source 1 can ensure that the laser beam incident on the speckle-eliminating element 2 is symmetrical with the laser beam emitting from the speckle-eliminating element 2, the speckle-eliminating effects every time the laser beam passes through the speckle-eliminating element 2 are the same, and the luminous efficacy is stable and controllable. In addition, the laser beam passing through the speckle-eliminating element 2 for the first time and the laser beam finally emitting from the speckle-eliminating element 2 are located on the same side of the speckle-eliminating element 2, so that the lengths of the post-stage light path structure and the speckle-eliminating light path structure are offset or partially offset mutually, which is conducive to shortening the overall length of the projection light path and ultimately reducing the volume of the entire speckle-eliminating light path structure.

In some examples, the included angle formed between the optical axis of the laser beam passing through the speckle-eliminating element 2 for the first time and the surface of the speckle-eliminating element 2 ranges from 60° to 90°. That is to say, the included angle formed between the optical axis of the laser beam passing through the speckle-eliminating element 2 for the first time and the surface of the speckle-eliminating element 2 and an included angle formed between the optical axis of the laser beam emitting from the speckle-eliminating element 2 and the surface of the speckle-eliminating element 2 are in the same range, which can ensure that the optical axis of the incident laser beam and the optical axis of the emergent laser beam of the speckle-eliminating element 2 remain symmetrical, the speckle-eliminating effects every time the laser beam passes through the speckle-eliminating element 2 are the same, and the luminous efficacy is stable and controllable. At the same time, the projection light path of the speckle-eliminating light path structure can be as short as possible, and an overall structure thereof is compact.

In some examples, as shown in FIG. 1, the included angle between the optical axis of the laser beam passing through the speckle-eliminating element 2 for the first time and the surface of the speckle-eliminating element 2 is 90°, and the included angle between the optical axis of the laser beam emitting after being reflected by the reflective light path assembly 3 and the surface of the speckle-eliminating element 2 is 90°. That is, the included angle between the optical axis of the laser beam passing through the speckle-eliminating element 2 for the first time and the normal of the speckle-eliminating element 2 is 0°, and the included angle between the optical axis of the laser beam emitting after being reflected by the reflective light path assembly 3 and the normal of the speckle-eliminating element 2 is 0°.

In other examples, the included angle between the optical axis of the laser beam passing through the speckle-eliminating element 2 for the first time and the normal of the speckle-eliminating element 2 can deviate by a certain angle, such as 5°, 10°, 15°, and 30°, and the included angle between the optical axis of the laser beam emitting after being reflected by the reflective light path assembly 3 and the normal of the speckle-eliminating element 2 can deviate by a certain angle, such as 5°, 10°, 15°, and 30°. As shown in FIG. 2, the included angle θ between the optical axis of the laser beam passing through the speckle-eliminating element 2 for the first time and the normal of the speckle-eliminating element 2 is 15°, and the included angle θ between the optical axis of the laser beam emitting after being reflected by the reflective light path assembly 3 and the normal of the speckle-eliminating element 2 is 15°. Compared with the speckle-eliminating light path structure shown in FIG. 1, the overall length of the speckle-eliminating light path structure in this example is shortened in the normal direction of the speckle-eliminating element 2.

It can be understood that within the range of 0° to 30° of the included angle formed between the optical axis of the laser beam and the normal of the speckle-eliminating element 2, with the change of the angle, the optical axis of the incident laser beam may be not perpendicular to the surface of the speckle-eliminating element 2, and the optical axis of the emergent laser beam may be not perpendicular to the surface of the speckle-eliminating element 2, and the incident laser beam and the emergent laser beam passing through the speckle-eliminating element 2 may not be symmetrical, which depends on application scenarios and will not be described in detail.

For example, an included angle formed between a normal of the first reflective surface 31 and the surface of the speckle-eliminating element 2 is in a range of 45°±15°. For example, an included angle formed between a normal of the second reflective surface 32 and the surface of the speckle-eliminating element 2 is in a range of 45°±15°. The angles of the first reflective surface 31 and the second reflective surface 32 are set thus, so that the incident laser beam and the emergent laser beam are substantially kept symmetrical, which shortens the length of the projection light path as much as possible, and the overall structure is compact, which is conducive to reducing the volume of the laser projection apparatus. The angle of the first reflective surface 31 and the second reflective surface 32 within this range can ensure that the included angle formed between the optical axis of the laser beam and the normal of the speckle-eliminating element 2 is in a range of 0° to 30°, thus improving the luminous efficacy of the speckle-eliminating light path structure. In some examples, at least one of the first reflective surface 31 and the second reflective surface 32 is a plane or a curved surface, and the curved surface is a concave surface. Further, the concave surface is any one of a spherical surface, an even aspherical surface or a free curved surface. The even aspherical surface may be any one of hyperboloid, paraboloid and ellipsoid.

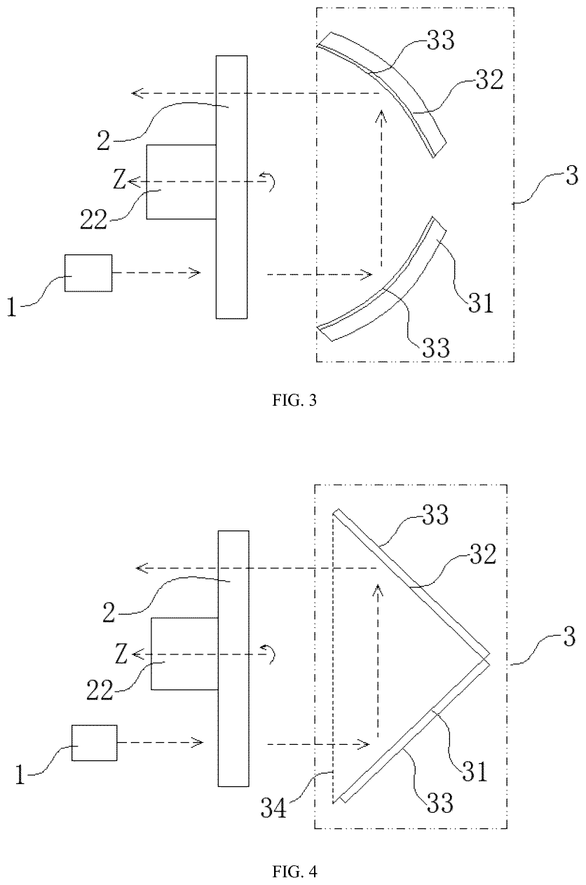

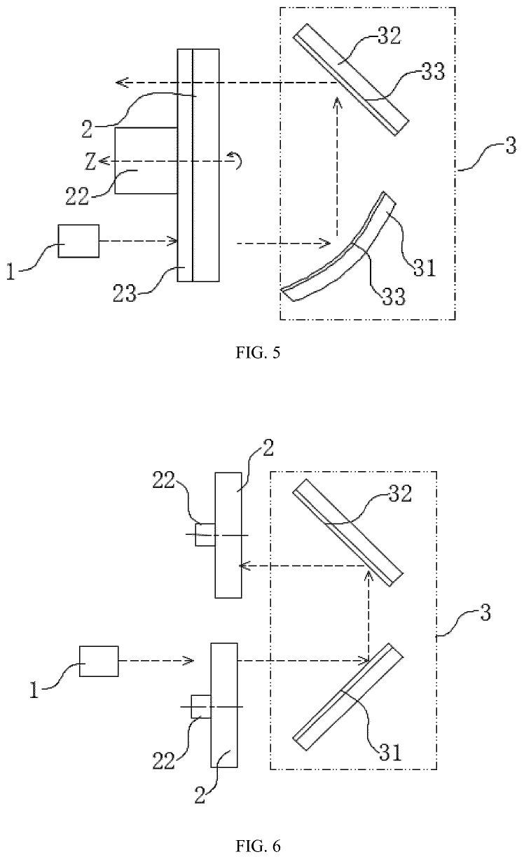

As shown in FIG. 1, the first reflective surface 31 and the second reflective surface 32 are both planes and normals thereof are perpendicular to each other, and the included angles between both the first reflective surface 31 and the second reflective surface 32 and the surface of the speckle-eliminating element 2 are 45°. As shown in FIG. 3, the first reflective surface 31 and the second reflective surface 32 are both curved surfaces and normals thereof are perpendicular to each other, and the included angles between both the normal of the first reflective surface 31 and the normal of the second reflective surface 32 and the normal of the speckle-eliminating element 2 are 45°. As shown in FIG. 5, one of the first reflective surface 31 and the second reflective surface 32 may be a plane, and the other may be a curved surface, and normals of the two surfaces are perpendicular to each other.

Further, the first reflective surface 31 and the second reflective surface 32 are further provided with a reflective film 33 which may be a dielectric reflective film or a metal reflective film. In an example, a material of the reflective film 33 is titanium dioxide, and is formed on the first reflective surface 31 and the second reflective surface 32 by spraying or coating to improve reflectivity of the first reflective surface 31 and the second reflective surface 32. For example, when the first reflective surface 31 and the second reflective surface 32 are smooth enough, the reflectivity of the first reflective surface 31 and the second reflective surface 32 can be improved by total reflection without plating the reflective film 33.

In some examples, the reflective light path assembly 3 includes a first reflective mirror 3a and a second reflective mirror 3b provided at preset angles, the first reflective mirror 3a is provided with the first reflective surface 31, and the second reflective mirror 3b is provided with the second reflective surface 32. Further, at least one of the first reflective mirror 3a and the second reflective mirror 3b is a planar mirror or a curved mirror, and a range of a preset angle between the first reflective mirror 3a and the second reflective mirror 3b may be 45°±15°.

In some examples, the reflective light path assembly 3 includes a triangular prism which includes the first reflective surface 31 and the second reflective surface 32 provided at preset angles and a transmissive surface 34 connecting the first reflective surface 31 and the second reflective surface 32. The transmissive surface 34 is provided toward the speckle-eliminating element 2.

As shown in FIG. 4, the reflective light path assembly 3 includes a triangular prism. The laser beam passing through the speckle-eliminating element 2 for the first time is transmitted through the transmissive surface 34 and is incident on the first reflective surface 31, reflected by the first reflective surface 31 to the second reflective surface 32, reflected by the second reflective surface 32, and transmitted through the transmissive surface 34 again and then emits. Further, a range of the preset angle between the first reflective surface 31 and the second reflective surface 32 may be 45°±15°. It can be understood that two mutually perpendicular sides of the triangular prism may also be covered with planar mirrors, and the two planar mirrors are used as the first reflective surface 31 and the second reflective surface 32.

In some examples, the speckle-eliminating light path structure includes a driving mechanism 22, the speckle-eliminating element 2 is a diffusion wheel, and a power output end of the driving mechanism 22 is provided coaxially with the diffusion wheel to drive the diffusion wheel to rotate.

As shown in FIG. 1 to FIG. 5, the speckle-eliminating element 2 is a diffusion wheel with a rough surface, and the driving mechanism 22 may be a motor which is provided coaxially with the diffusion wheel to drive the diffusion wheel to rotate around its own center (e.g., Z-axis direction marked in the drawings), thereby improving the speckle-eliminating effect on the laser beam. In addition, since an area where the diffusion wheel overlaps the motor cannot transmit the laser beam, the motor is provided on a side of the diffusion wheel toward the laser light source 1, so that the motor can be prevented from blocking the projection light path of the laser beam, and the utilization rate of the speckle-eliminating element 2 can be improved.

Further, the diffusion wheel has a disc structure, and a diameter d thereof ranges from 20 mm to 60 mm. For example, the minimum distance between the speckle-eliminating element 2 and the reflective light path assembly 3 is 0.1 d to 2 d. As shown in FIG. 4, the reflective light path assembly 3 is a triangular prism, and the distance between the speckle-eliminating element 2 and the transmissive surface 34 of the triangular prism is 0.1 d to 2 d. In an example, the distance between the speckle-eliminating element 2 and the transmissive surface 34 of the triangular prism is 0.42 d, which can further shorten the overall length of the projection light path, reduce the overall occupied space of the speckle-eliminating light path structure, and thus reduce the volume of the laser projection apparatus on the premise of ensuring the luminous efficacy.

As shown in FIGS. 1 to 5, the number of diffusion wheels is one, and the driving mechanism 22 is located on the side of the diffusion wheel toward the laser light source 1 and provided coaxially with the diffusion wheel. The area where the diffusion wheel overlaps the driving mechanism 22 cannot transmit the laser beam, and a transmitting area of the diffusion wheel is of an annular structure. When the driving mechanism 22 drives the diffusion wheel to rotate, the laser beam passing through the diffusion wheel for the first time is located on one side of a rotation axis of the driving mechanism 22, and the laser beam passing through the diffusion wheel for the second time is located on the other side of the rotation axis of the driving mechanism 22. For example, a connecting line between the position where the laser beam passes through the diffusion wheel twice and the rotation axis forms an included angle of 180° (the included angle may be smaller, but when the included angle is 180°, a diameter of the diffusion wheel is smallest, which is conducive to reducing the volume of the speckle-eliminating light path), to improve the utilization rate of the speckle-eliminating element 2. The speckles of the laser beam can be eliminated twice by one speckle-eliminating element 2, which can effectively improve the speckle-eliminating effect, reduce the overall volume of the speckle-eliminating light path structure, and has low cost.

When the laser beam is incident on the diffusion wheel at an oblique angle, for example, when the angle formed between the optical axis of the laser beam and the normal of the diffusion wheel is 30°, the laser beam emitting from the diffusion wheel after being reflected by the reflective light path assembly 3 may reach the area where the diffusion wheel overlaps the driving mechanism 22 and cannot transmit the laser beam, so it sets the diameter of the diffusion wheel to be large enough, but the utilization rate of the diffusion wheel may be reduced, and the fabricating cost is high.

Therefore, as shown in FIG. 6, the number of diffusion wheels is two, and the two diffusion wheels are coplanar and disposed at intervals. A side of one diffusion wheel located at a rotation axis of a driving mechanism is configured to transmit the laser beam for the first time, and a side of the other diffusion wheel located at a rotation axis of a driving mechanism is configured to transmit the laser beam for the second time. In this way, the diameter of the diffusion wheel can be made relatively small, which reduces the fabricating cost of the diffusion wheel and may not increase the overall length of the projection light path, and is conducive to reducing the occupied space of the speckle-eliminating light path structure.

Further, a half-wave plate 23 is further provided on the side of the speckle-eliminating element 2 toward the laser light source 1. As shown in FIG. 5, the half-wave plate 23 is a birefringent crystal with a certain thickness. When normally incident light passes through, phase difference between ordinary light (O light) and extraordinary light (E light) is equal to π or odd multiples of π. Such a wafer is called a half-wave plate. When O light propagates in the crystal, no matter which direction the light is incident, the refractive index is fixed and shows isotropic properties. A vibration direction of E light is perpendicular to a vibration direction of O light, which leads to different refractive indexes when the light propagates in different directions. The optical axis of the half-wave plate 23 is in a fixed direction, and the half-wave plate 23 rotates with the rotation of the diffusion wheel when the half-wave plate 23 is connected with the diffusion wheel as a whole, so the polarization direction of the laser light passing through the half-wave plate 23 always changes, thereby further improving the effect of speckle elimination.

In some examples, the speckle-eliminating light path structure includes the driving mechanism 22, the speckle-eliminating element 2 is a vibration diffuser, and the driving mechanism 22 drives the vibration diffuser to vibrate in any one of XY plane, YZ plane and XZ plane.

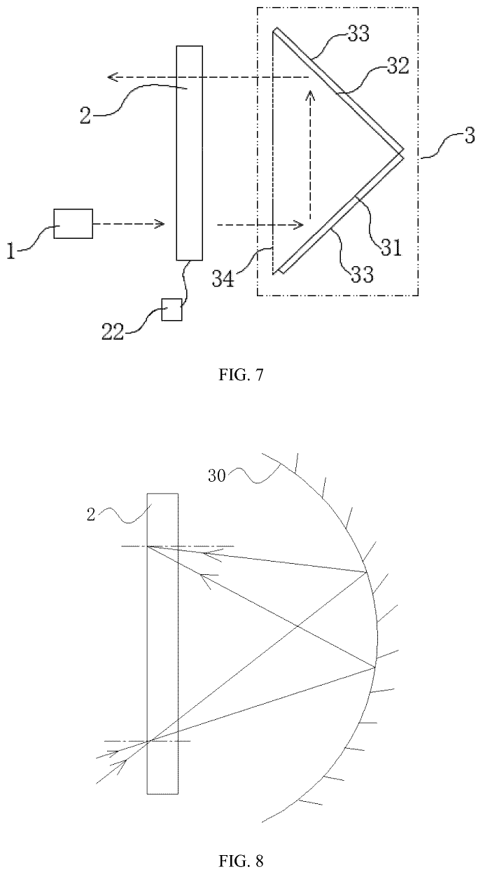

As shown in FIG. 7, the driving mechanism 22 is a vibration controller, and the vibration diffuser is a square diffuser. The driving mechanism 22 drives the vibration diffuser to vibrate in any one of the XY plane, YZ plane and XZ plane along a preset trajectory, which can effectively improve the speckle-eliminating effect on the laser beam.

Further, a shape of the vibration diffuser is rectangular, and a dimension L of a diagonal of the vibration diffuser ranges from 20 mm to 60 mm. For example, the minimum distance between the vibration diffuser and the reflective light path assembly is 0.1 L to 2 L. When the reflective light path assembly 3 is a triangular prism, the distance between the vibration diffuser and the transmissive surface 34 of the triangular prism is 0.1 L to 2 L. In an example, the distance between the vibration diffuser and the transmissive surface 34 of the triangular prism is 0.42 L, which can further shorten the overall length of the projection light path, reduce the overall occupied space of the speckle-eliminating light path structure, and thus reduce the volume of the laser projection apparatus on the premise of ensuring the luminous efficacy.

In addition, an example of the present disclosure provides a speckle-eliminating light path structure which is similar to the structures shown in FIGS. 1 to 7 and can suppress the speckles of the laser beam twice, except that the reflective light path assembly 3 has only one reflective surface.

Specifically, as shown in FIG. 8, the speckle-eliminating element 2 is a diffusion wheel, the driving mechanism 22 is a motor, and the reflective light path assembly 3 is provided on a side of the speckle-eliminating element 2 away from the laser light source 1 and includes one reflective surface 30. The laser beam passing through the speckle-eliminating element 2 for the first time is incident on the reflective surface 30 and is reflected by the reflective surface 30, and then passes through the speckle-eliminating element 2 for the second time and emits from the speckle-eliminating element 2. The reflective surface 30 may be a plane, and a lens for condensing light may be provided in front of the reflective surface 30. The reflective surface 30 may also be curved and concave. Further, the concave surface is any one of a spherical surface, an even aspherical surface or a free curved surface. The even aspheric surface may be any one of hyperboloid, paraboloid and ellipsoid.

When the distance between the reflective surface 30 and the speckle-eliminating element 2 meets preset conditions, the included angle between the optical axis of the emergent light passing through the speckle-eliminating element 2 again and the surface of the speckle-eliminating element 2 may be in a range of 60° to 90° through one reflective surface 30. Specifically, the larger the size of the speckle-eliminating element 2 is, the greater the distance is, and the distance is not specifically limited in the present disclosure, and those skilled in the art can adaptively adjust the distance according to the size of the speckle-eliminating element 2. It can be understood that the speckle-eliminating element 2 may also be a vibration diffuser, and the driving mechanism 22 may be a vibration controller.

In addition, an example of the present disclosure provides a speckle-eliminating light path structure which is similar to the structures shown in FIGS. 1 to 7 in that the reflective light path assembly 3 includes a first reflective surface 31 and a second reflective surface 32, and is different in that the speckle-eliminating element 2 is in different positions relative to the reflective light path assembly 3 and can suppress the speckles of the laser beam more times.

The speckle-eliminating element 2 is a vibration diffuser, the driving mechanism 22 is a vibration controller, and the reflective light path assembly 3 includes the first reflective surface 31 and the second reflective surface 32 which are opposite and disposed at intervals on two sides of the speckle-eliminating element 2; the laser beam emitted by the laser light source 1 passes through the speckle-eliminating element 2 for the first time and is incident on the first reflective surface 31, is reflected by the first reflective surface 31 and then passes through the speckle-eliminating element 2 for the second time and enters the second reflective surface 32, and is reflected by the second reflective surface 32 and then passes through the speckle-eliminating element 2 for the third time and emits. Therefore, the speckles of laser beam can be suppressed for three times, which greatly improves the speckle-eliminating effect on the laser. In addition, the light passing through the speckle-eliminating element 2 for the first time and the light finally emitting from the speckle-eliminating element 2 are located on different sides of the speckle-eliminating element 2, so that the overall length of the post-stage light path structure and the speckle-eliminating light path structure are added. It can be understood that the speckle-eliminating element 2 may be a diffusion wheel, and the driving mechanism 22 may be a motor.

In some examples, the number of the first reflective surfaces 31 and the second reflective surfaces 32 may be plural respectively, and the first reflective surfaces 31 and the second reflective surfaces 32 are provided on both sides of the speckle-eliminating element 2, and the two first reflective surfaces 31 and the two second reflective surfaces 32 are provided on both sides of the speckle-eliminating element 2, so that the laser beam emitted by the laser light source 1 can pass through the speckle-eliminating element 2 for four times to suppress the speckles of the laser beam for four times, and further improve the speckle-eliminating effect on the laser. The speckle-eliminating elements 2 may be two speckle-eliminating elements 2 which are coplanar and disposed at intervals, or three or more speckle-eliminating elements 2 provided as needed. In the present disclosure, since the first reflective surfaces 31 and the second reflective surfaces 32 are provided on both sides of the speckle-eliminating element 2, a group of first reflective surface 31 and second reflective surface 32 can be provided corresponding to the same speckle-eliminating element 2, so that the same speckle-eliminating element 2 can suppress the speckles of the laser beam twice with the first reflective surface 31 and the second reflective surface 32, and two or more speckle-eliminating elements 2 can suppress the speckles of the laser beam more than three times, such as four times, five times and six times, and then enter the post-stage light path.

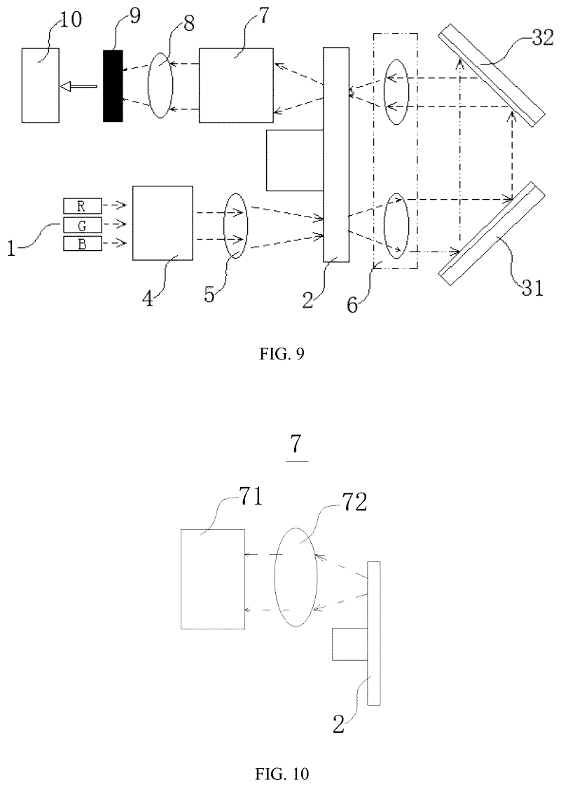

As shown in FIG. 9, an example of the present disclosure further provides a laser projection apparatus, including: the speckle-eliminating light path structure as described above, a first lens assembly 8, an image display device 9 and a lens 10.

The first lens assembly 8 is provided between the reflective light path assembly 3 of the speckle-eliminating light path structure and the image display device 9 and is configured to gather the laser beam from the speckle-eliminating light path structure to the image display device 9 to form an illumination light spot. The first lens assembly 8 includes at least one lens which is a convex lens for gathering parallel light beams on the image display device 9. The image display device 9 is a digital mirror device (DMD), a reflective liquid crystal on silicon (LCOS) or a transmissive liquid crystal display (LCD). The size of the illumination light spot matches the size of the image display device 9. For example, the illumination light spot and the image display device 9 are all rectangular. The lens 10 is configured to project the image information from the image display device 9 onto the screen.

Further, the speckle-eliminating light path structure shown in FIGS. 1 to 7 is applied to the laser projection apparatus, and the reflective light path assembly 3 is provided on a side of the speckle-eliminating element 2 away from the laser light source 1, and includes the first reflective surface 31 and the second reflective surface 32 provided at preset angles. The laser projection apparatus further includes a second lens assembly 5 and a third lens assembly 6.

The second lens assembly 5 is provided between the laser light source 1 and the speckle-eliminating element 2 in the speckle-eliminating light path structure, is configured to focus the laser beam on the speckle-eliminating element 2, and includes at least one lens which is a convex lens for gathering light.

The third lens assembly 6 is provided between the speckle-eliminating element 2 and the reflective light path assembly 3, and is configured to cause the laser beam focused on the speckle- eliminating element 2 to diverge and be incident on the first reflective surface 31 of the reflective light path assembly 3. The laser beam from the first reflective surface 31 emits via the second reflective surface 32 and enters the third lens assembly 6 again, is gathered and then enters the speckle-eliminating element 2 again. The third lens assembly 6 includes one lens or two lenses. Two parts of one lens or two lenses aligned in a straight line correspond to the laser beam entering the first reflective surface 31 and the laser beam emitting from the second reflective surface 32 respectively. Part of one lens or one lens is configured to emit the gathered light beam emitting from the speckle-eliminating element 2 to the first reflective surface 31 in parallel, and the other part of the lens or the other lens is configured to gather the parallel incident light beams to the speckle-eliminating element 2. Therefore, both the incident laser beam and the emergent laser beam are focused on a transmission area of the speckle-eliminating element 2, which can minimize increase of etendue of the system, reduce the volume of the projection light path, and improve the luminous efficacy and contrast of the laser projection apparatus.

Further, the laser projection apparatus further includes: a light uniformizing assembly 7.

The light uniformizing assembly 7 is provided between the reflective light path assembly 3 and the first lens assembly 8, and is configured to uniformize and shape the laser beam emitting from the speckle-eliminating element 2.

In some examples, the light uniformizing assembly 7 includes a fly-eye lens 71 and a fourth lens assembly 72, and the fourth lens assembly 72 is provided between the speckle-eliminating element 2 and the fly-eye lens 71 to collimate the light emitting from the speckle-eliminating element 2.

As shown in FIG. 10, the fourth lens assembly 72 includes at least one lens which is a convex lens configured to emit the uniformized gathered light in parallel. The fly-eye lens 71 is configured to convolute the laser beam in space to make the laser beam illuminating the image display device 9 more uniform.

Specifically, the fly-eye lens 71 is composed of a series of lenslets. To achieve uniform illumination, two fly-eye lens arrays need to be arranged in parallel. A focus of each small unit lens in the first fly-eye lens array coincides with a center of the corresponding small unit lens in the second fly-eye lens array, and optical axes of the two fly-eye lens arrays are parallel to each other. A condenser is placed behind the second fly-eye lens array, and an illumination screen is placed on a focal plane of the condenser to form a uniform illumination system, so that the double fly-eye lens arrays can obtain a high light energy utilization rate and uniform illumination in a large area, which has a broad application prospect in the field of projection display.

Light path principles of the fly-eye lens 71 are as follows: the light beam parallel to the optical axis passes through the first lens and is focused at the center of the second lens, the first fly-eye lens and a light source form a plurality of light sources for illumination, and lenslets of the second fly-eye lens overlap and image a plurality of lenslets of the first fly-eye lens on an illuminated surface. The first fly-eye lens divides a whole wide light beam of the light source into a plurality of thin light beams for illumination, lateral non-uniformity within each thin light beam is compensated by mutual superposition of thin light beams at symmetrical positions, so that light energy within a whole aperture can be effectively and uniformly utilized. Light spots emitting from the second fly-eye lens are focused on the illumination screen through the condenser, so that each of the light spots on the illumination screen is illuminated by light emitted from all points of the light source, and at the same time, light beams emitted from each point of the light source converge and overlap in the same field of view of the illuminated light spot, so that a uniform square light spot can be obtained.

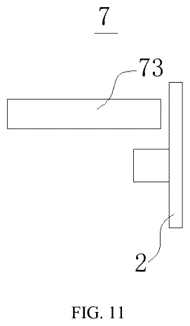

In some examples, the light uniformizing assembly 7 is a quadrangular cylinder with a rectangular or trapezoidal cross section. As shown in FIG. 11, the light uniformizing assembly 7 is a square bar 73, which may be made of glass and may be a hollow or solid quadrangular cylinder.

Further, the laser light source 1 includes a red laser R, a green laser G and a blue laser B, and the laser projection apparatus further includes a light combining assembly 4 which is provided between the laser light source 1 and the speckle-eliminating element 2 and is configured to combine the laser beams emitted by the laser light source 1 into a beam of light. The red laser R, the green laser G and the blue laser B respectively emit red, green and blue laser beams, which are combined into a white laser beam by the light combining assembly 4.

It can be understood that when the speckle-eliminating light path structure shown in FIG. 8 is applied to the laser projection apparatus, the reflective light path assembly 3 is provided on the side of the speckle-eliminating element 2 away from the laser light source 1 and includes only one reflective surface 30, and the laser projection apparatus may also include the second lens assembly 5, the third lens assembly 6, the light uniformizing assembly 7 and the light combining assembly 4 as described above. When the reflective surface 30 is flat, the third lens assembly 6 is configured to gather light to the reflective surface; when the reflective surface 30 is curved, the third lens assembly 6 can be omitted and will not be repeated. The laser beam suppresses speckles twice through one reflective surface 30 of the reflective light path assembly 3 and the speckle-eliminating element 2, then focuses on the light uniformizing assembly 7, and illuminates the image display device 9 by uniformizing and shaping of the light-uniformizing assembly 7 to form an illumination light spot, and the image information from the image display device 9 is projected onto the screen through the lens 10.

When the reflective light path assembly 3 includes the first reflective surface 31 and the second reflective surface 32 which are disposed opposite at intervals, the speckle-eliminating element 2 is provided between the first reflective surface 31 and the second reflective surface 32, and the laser projection apparatus may also include the second lens assembly 5, the light uniformizing assembly 7 and the light combining assembly 4 as mentioned above, in which the second lens assembly 5 may be a combination of convex lens and concave lens configured to emit the gathered light to the first reflective surface 31 in parallel, and will not be described in detail. The laser beam suppresses speckles multiple times through the reflective light path assembly 3 and the speckle-eliminating element 2, then focuses on the light uniformizing assembly 7, and illuminates the image display device 9 by uniformizing and shaping of the light-uniformizing assembly 7 to form an illumination light spot, and the image information from the image display device 9 is projected onto the screen through the lens 10.

The laser projection apparatus provided in the example of the present disclosure adopts the speckle-eliminating light path structure as mentioned above, which can not only suppress the speckles of the laser beam at least twice and effectively improve the speckle-eliminating effect, but also shorten the overall length of the projection light path, so that the volume of the laser projection apparatus is reduced to the size of a can with compact structure, light weight, strong removability and portability, and is widely used in travel and business.

It should be readily understood that the terms “on”, “upon” and “above” in the present disclosure should be interpreted in a broadest manner such that “on” not only means “directly on something”, but also means “above something” and there is an intermediate feature or layer, and “upon” or “above” not only means “upon something” or “above something”, but also means “upon something” or “above something” and there is no intermediate feature or layer (i.e., directly on something).

Further, spatially relative terms such as “under”, “below”, “underneath”, “above” and “on” may be used herein for ease of description to describe the relationship of one element or feature with respect to other elements or features as shown in the drawings. The spatially relative terms are intended to encompass different orientations of the device in use or operation in addition to the orientation shown in the drawings. The device may have other orientations (rotated 90 degrees or in other orientations), and spatially relative descriptors used herein may be likewise interpreted accordingly.

It should be noted that relationship terms such as “first” and “second” are used solely for distinguishing one entity or operation from another entity or operation herein without necessarily requiring or implying any actual relationship or order among the entities or operations. Furthermore, the terms “include”, “comprise”, or any other variants thereof are intended to encompass non-exclusive inclusion, so that a process, method, article, or device comprising a series of elements not only comprises those elements but further comprises other elements not expressly listed or elements inherent to such a process, method, article or device. Without more limitations, an element defined by a phrase “comprise a . . . ” does not exclude the presence of additional identical elements in the process, method, article, or device that comprises the element.

At last, it should be noted that: the above examples are only used to describe rather than limiting the solutions of the present disclosure; although the present disclosure is described in detail with reference to the foregoing examples, a person skilled in the art should understand that: modifications can still be made to the solutions described in the foregoing examples, or equivalent substitutions can be made to part or all of the features; these modifications or substitutions do not cause the spirit of the corresponding solutions to depart from the scope of the solutions of the examples of the present disclosure.

What is claimed is:

1. A speckle-eliminating light path system comprising:
a laser light source configured to emit a laser beam;
a reflective light path assembly comprising a reflective surface; and
a speckle-eliminating device configured to:
receive the laser beam in a first direction;
transmit the laser beam to the reflective surface at an angle of 60° to 90° relative to a surface of the speckle-eliminating device;
after the laser beam being reflected by the reflective surface, receive the laser beam again in a second direction; and
transmit the laser beam to an optical device.

2. The speckle-eliminating light path system according to claim 1, wherein the reflective light path assembly is arranged on a side of the speckle-eliminating device away from the laser light source and comprises a first reflective surface and a second reflective surface at preset angles, and
wherein the laser beam emitted by the laser light source is transmitted by the speckle-eliminating device for a first time, reaches the first reflective surface, is reflected by the first reflective surface to the second reflective surface, is reflected by the second reflective surface, is received by the speckle-eliminating device for a second time, and is transmitted by the speckle-eliminating device.

3. The speckle-eliminating light path system according to claim 2, wherein an included angle between an optical axis of the laser beam transmitted by the speckle-eliminating device for the first time and the surface of the speckle-eliminating device is in a range of 60° to 90°.

4. The speckle-eliminating light path system according to claim 2, wherein an included angle formed between a normal of the first reflective surface and the surface of the speckle-eliminating device is in a range of 45°±15°, and
wherein an included angle formed between a normal of the second reflective surface and
the surface of the speckle-eliminating device is in a range of 45°±15°.

5. The speckle-eliminating light path system according to claim 2, wherein at least one of the first reflective surface and the second reflective surface is a plane or a curved surface, wherein the curved surface is a concave surface, and wherein the concave surface is one of a spherical surface, an even aspherical surface, or a free curved surface.

6. The speckle-eliminating light path system according to claim 2, wherein each the first reflective surface and the second reflective surface comprises a reflective film.

7. The speckle-eliminating light path system according to claim 2, wherein the reflective light path assembly comprises a first reflective mirror and a second reflective mirror at preset angles, the first reflective mirror comprises the first reflective surface, and the second reflective mirror comprises the second reflective surface.

8. The speckle-eliminating light path system according to claim 2, wherein the reflective light path assembly comprises a triangular prism comprising the first reflective surface and the second reflective surface at preset angles and a transmissive surface connecting the first reflective surface and the second reflective surface, and wherein the transmissive surface is arranged toward the speckle-eliminating device.

9. The speckle-eliminating light path system according to claim 1, wherein the speckle-eliminating device comprises at least one of a vibration diffuser, a rotary diffusion wheel, or a diffractive optical device.

10. The speckle-eliminating light path system according to claim 1, further comprising a driving mechanism, wherein the speckle-eliminating device is a diffusion wheel with a diameter d, and a power output end of the driving mechanism is positioned coaxially with the diffusion wheel to drive the diffusion wheel to rotate.

11. The speckle-eliminating light path system according to claim 10, wherein the diffusion wheel has a disc structure, and the diameter d ranges from 20 mm to 60 mm.

12. The speckle-eliminating light path system according to claim 10, wherein a minimum distance between the diffusion wheel and the reflective light path assembly is 0.1 d to 2 d.

13. The speckle-eliminating light path system according to claim 1, wherein a side of the speckle-eliminating device toward the laser light source comprises a half-wave plate, and wherein the half-wave plate is positioned coaxially with and connected with the speckle-eliminating device.

14. The speckle-eliminating light path system according to claim 1, further comprising a driving mechanism, wherein the speckle-eliminating device is a vibration diffuser, and the driving mechanism drives the vibration diffuser to vibrate in one of an XY plane, a YZ plane, or an XZ plane.

15. The speckle-eliminating light path system according to claim 14, wherein a shape of the vibration diffuser is rectangular, and a diagonal of the vibration diffuser has a dimension L ranging from 20 mm to 60 mm, and wherein a minimum distance between the vibration diffuser and the reflective light path assembly is 0.1 L to 2 L.

16. The speckle-eliminating light path system according to claim 1, wherein the optical device comprises at least one of a condensing lens, a light uniformizing assembly, an image display device, or a lens.

17. A laser projection apparatus comprising:
a speckle-eliminating light path system, wherein the speckle-eliminating light path system comprises:
a laser light source configured to emit a laser beam;
a reflective light path assembly comprising a reflective surface; and
a speckle-eliminating device configured to:
receive the laser beam in a first direction;
transmit the laser beam to the reflective surface at an angle of 60° to 90° relative to a surface of the speckle-eliminating device;
after the laser beam being reflected by the reflective surface, receive the laser beam again in a second direction; and
transmit the laser beam to an optical device;
a first lens assembly and an image display device, wherein the first lens assembly is arranged between the speckle-eliminating light path system and the image display device, and is configured to gather the laser beam from the speckle-eliminating light path system to the image display device to form an illumination light spot; and
a lens configured to project image information from the image display device onto a screen.

18. The laser projection apparatus according to claim 17, wherein the reflective light path assembly is arranged on a side of the speckle-eliminating device away from the laser light source and comprises a first reflective surface and a second reflective surface at preset angles, and wherein
the laser projection apparatus further comprises:
a second lens assembly arranged between the laser light source and the speckle-eliminating device of the speckle-eliminating light path system, and configured to focus the laser beam on the speckle-eliminating device;
a third lens assembly arranged between the speckle-eliminating device and the reflective light path assembly, and configured to cause the laser beam focused on the speckle-eliminating device to diverge and to reach on the first reflective surface of the reflective light path assembly, wherein the laser beam from the first reflective surface emits via the second reflective surface, enters the third lens assembly again, is gathered, and is received by the speckle-eliminating device again; and
a light uniformizing assembly arranged between the reflective light path assembly and the first lens assembly, and configured to uniformize and shape the laser beam transmitted by the speckle-eliminating device.

19. The laser projection apparatus according to claim 18, wherein the light uniformizing assembly comprises a fly-eye lens and a fourth lens assembly, the fourth lens assembly is arranged between the speckle-eliminating device and the fly-eye lens to collimate the laser beam transmitted by the speckle-eliminating device, and
wherein the light uniformizing assembly is a quadrangular cylinder with a rectangular or trapezoidal cross section.

20. A method comprising:
receiving, by a speckle-eliminating device, a laser beam in a first direction from a laser light source;
transmitting, by the speckle-eliminating device, the laser beam to a reflective surface at an angle of 60° to 90° relative to a surface of the speckle-eliminating device;
after the laser beam being reflected by the reflective surface, receiving, by the speckle-eliminating device, the laser beam again in a second direction; and
transmitting, by the speckle-eliminating device, the laser beam to an optical device.
